(19) United States
(12) Patent Application Publication
(10) Pub. No.: US 2025/0067477 A1
(43) Pub. Date: Feb. 27, 2025

(54) RACKING-SYSTEM FOR FLAT PANELS

(71) Applicant: AEROCOMPACT Group Holding AG, Wien (AT)

(72) Inventor: Markus M. Burger, St. Gallenkirch (AT)

(21) Appl. No.: 18/811,497

(22) Filed: Aug. 21, 2024

(30) Foreign Application Priority Data
Aug. 22, 2023 (EP) 23 192 615.5

(51) Int. Cl. F24S 25/60; F16B 2/20

(52) U.S. Cl. CPC F24S 25/60; F16B 2/20; F24S 2025/6004

(57) ABSTRACT

The invention relates to a mounting device (1), in particular flat roof or open space mounting system, for surface elements, preferably photovoltaic or solar thermal modules, having a ground contact element (2) which preferably also serves to accommodate ballast weights and having a fixing bracket (3) which is connectable to the ground contact element (2) and comprises or is able to receive fixing elements (4), in particular clips, at an end facing away from the ground contact element (2), said fixing elements (4) serving to fix the surface elements (16), wherein it is provided that the connection between the ground contact element (2) and the fixing bracket (3) is detachable.

### BACKGROUND OF THE INVENTION

The invention relates to a mounting device, in particular a flat roof or open space mounting system, for surface elements, preferably photovoltaic or solar thermal modules.

Mounting devices for photovoltaic modules or solar thermal modules on flat roofs or open spaces are generally known from the state of the art. In this case, the mounting devices usually comprise at least one mounting base for being disposed on a ground side or fixed to a roof structure and a clip or clamping element for securing the support elements or surface elements, in particular the photovoltaic or solar thermal modules. The clip elements can be fixed, preferably screwed, to an upper border of the mounting base, for example.

The mounting base is, for example, tub-shaped in order to be able to accommodate large volumes of ballast elements, such as ballast stones or bulk material, when being disposed on the ground side, whereby the tub is weighted down and a stable positioning of the mounting device on a flat open space is made possible. Furthermore, the tub can be stepped in order to obtain two different levels of the upper border of the mounting base such that, when surface elements are connected via two adjacent mounting bases with the same orientation, a beveled orientation of the surface elements is enabled by an alternating arrangement on the higher or lower step of the border of the mounting base, as shown in U.S. Pat. Nos. 9,831,817 B2, 9,057,544 B2 and 11,689,148 B2, for example.

From WO 2023/133511 A2, a mounting device having a sled-shaped mounting base is known, the sides of the sled also being stepped here.

All generic designs have the disadvantage that, due to the realization of the steps on the respective mounting base, the arrangement options of the surface elements are also limited by these preset steps of the mounting base and that an adjustment, in particular during mounting, is not possible or only possible with difficulty. The thermal expansion of the components involved also entails that the mounting bases perform a caterpillar movement with respect to the substratum when they are heated or cooled. In this case, the asymmetrical design of these mounting bases also complicates the flexible use for different mounting situations. Thus, for example, only an arrangement of surface elements having a consistent and/or constant inclination is possible. This may be desired in the case of south orientations of mounting elements, for example. However, in the case of an east-west orientation, an alternating inclination can be more advantageous in order to be able to use both the morning sun and the afternoon sun particularly effectively. This alternating inclination of the surface elements cannot be achieved with the known asymmetrical ballast tubs.

Furthermore, the known mounting bases are also only suitable for enabling exactly one arrangement of the surface elements. A use which can be adapted to different mounting situations cannot be realized.

The clip or clamping elements usually have a partially flat support area for abutment against a support element and are screwed into the mounting base at defined positions.

Typically, the fixing members are fixed in or on the mounting device along the perpendicular direction and screwed from the opposite side or screwed to an opposing nut from the side of their abutment. This significantly increases the mounting effort of such mounting devices, particularly if the screw or nut is countersunk below a projecting border and in particular after the mounting base has been fixed in its position by filling in ballast, adjustments can be made only with difficulty.

Moreover, mounting devices which are provided in a pre-mounted manner are known. On the one hand, this results in disadvantages for the transportation since mounting devices take up a lot of space or volume. On the other hand, such devices are also very limited in their adaptability, which is why they can only be used to a limited extent. In addition, the problem exists that these mounting devices are not stiff enough such that, despite the ballast used, such a reliable introduction of forces without unwanted plastic deformation cannot be ensured. Furthermore, pre-mounting takes a lot of time and causes a high level of effort.

### SUMMARY OF THE INVENTION

In the light of the above, the object of the present invention is to overcome the disadvantages of the state of the art, in particular to propose a mounting device which is flexibly adjustable and has improved mechanical properties and is easy to mount.

This object is attained by a mounting device having the features disclosed herein. Furthermore, this object is attained by a mounting system having the features disclosed herein.

Advantageous embodiments of the mounting device according to the invention and the mounting system are the subject matter of the subsequent description and the description of the figures and the dependent claims.

The features described and claimed with respect to the device are also to be regarded as disclosed correspondingly with respect to the method and claimable, and vice versa.

As already mentioned above, the mounting device is intended for use as, in particular, flat roof or open space mounting system for surface elements, preferably photovoltaic or solar thermal modules.

In this case, the mounting device comprises a ground contact element which preferably also serves to accommodate ballast weights. The ground contact element comes directly into contact with the substratum or ground, for example, on or with a bottom side of the ground contact element.

Furthermore, the mounting device comprises a fixing bracket which is detachably connectable to the ground contact element and comprises or is able to receive fixing elements, in particular clips, at an end facing away from the ground contact element, said fixing elements serving to fix the surface elements.

The ground contact element is understood to be the element of the mounting device which is in contact with the ground or a, in particular flat, roof structure. In this case, at least part of the surface of the ground contact element abuts against the ground or the roof structure. The ground contact element can consist of different, preferably weather-resistant, materials or material combinations, plastic or metal being conceivable, for example. Plastic is particularly suitable for a use in the context of a green roof. It is particularly advantageous if the ground contact element has no sharp corners or edges so as not to damage film materials of the roof structure.

For example, bulk material or gravel can be provided as ballast, wherein weighting down with large pieces of, for example, brick fragments, natural stones, concrete or cement blocks or sandbags is also possible.

The fixing bracket can have different embodiments, which can be realized differently, for example, depending on the terrain inclination and/or properties and/or mounting situation. Basically, the fixing bracket enables a stable support of the surface elements which is also guaranteed in the case of weather-related influences, such as strong winds or a temperature increase or drop. The fixing brackets establish the essential distance in the height direction (vertical) between an upper border of the ground contact element and the surface elements which are fixed indirectly or directly to the end facing away from the ground contact element. Due to the detachable connection between ground contact element and fixing bracket, particular advantages can be achieved. At first, different fixing brackets can be connected to a, preferably standardized, ground contact element. This allows a flexible adaptation to the respective mounting situation, while at the same time providing a maximum number of identical parts. Furthermore, this detachable connection between ground contact element and fixing bracket allows a stiffening of the mounting device in areas in which stiffness is desired and a mechanical elasticity in areas in which this is advantageous. Thus, the connection between ground contact element and fixing bracket can stiffen the two components additionally mutually in the area of the connection. Moreover, however, depending on the configuration, the fixing brackets are flexible or partially elastic away from or beyond the connection to the ground contact element such that forces can be absorbed and deflected particularly well. The aforementioned advantages together also allow in a particularly advantageous manner the realization of fixed and movable bearings of the surface elements by suitably selecting the respective fixing brackets in a sequence of the mounting devices.

In addition, the present invention has found the detachable connection of ground contact element and fixing bracket makes a transportation and support of the components of the mounting device easier and, simultaneously, enables a quick and easy mounting, dismounting and adjustment of the mounting device.

This is because, due to the detachably realized connection, the mounting device can be brought to the installation site in a state in which it is disassembled into its individual parts, which ensures a particularly space-saving and reliable packaging and a volume- and space saving shipping. Differently realized elements of the mounting device can also be combined in order to ensure an optimal adaptation to the existing substratum and the planned mounting project. The connection of different fixing brackets to a standardized or uniform ground contact element enables, in addition, different arrangement patterns (up-down-up for, for example, east-west arrangements or saw tooth for south arrangements) and inclinations of the surface elements.

In this case, the ground contact element can already be at least partially fixed to a defined place by means of ballast, which prevents a displacement of the ground contact element during the following mounting steps and, accordingly, avoids a complex restoration of originally measured positions. In the following, the fixing brackets can be connected to the ground contact element, wherein time and effort can be reduced, particularly when installing a plurality of mounting devices, by means of a design without tools since the individual mounting process is accelerated and, for example, several mounting devices can be worked on simultaneously without being limited due to the availability of tools.

According to a first advantageous embodiment, the connection between the ground contact element and the fixing bracket may be detachable, preferably without tools, and may be establishable without tools.

The abutment of the surface elements against the fixing bracket can be established and detached, preferably without tools, by means of fixing members, in particular clips, wherein other embodiments, both without tools and depending on tools, such as screw connections or insertion connections, are possible. Totally optionally, the fixing members can have coatings, such as rubber linings or coats of varnish.

The design of the connection without tools, particularly when installing a plurality of mounting devices, can reduce a lot of time and effort since the individual mounting process is accelerated and, for example, several mounting devices can be worked on simultaneously without being limited due to the availability of tools.

Furthermore, advantageously, the connection between the ground contact element and the fixing brackets may be realized as an insertion connection.

This can particularly advantageously enable a simple mounting, wherein, still, an existence of the connection is ensured. Furthermore, the insertion connection can be preferably at least partially planar, whereby the connection is reinforced due to surface adhesion. Further preferably, the insertion connection can have at least partially guiding aids in order to make the mounting, in particular on the ground, easier.

According to another advantageous embodiment, the insertion connection may be realized in such a manner that an insertion direction runs essentially parallel to a base plane, preferably parallel to a longitudinal direction, of the ground contact element.

On the one hand, this makes the mounting of the fixing bracket on the ground contact element particularly easy and, on the other hand, the connection becomes particularly stable due to the insertion along the longitudinal direction since in particular a tilting or wobbling of an inserted fixing bracket, as it often occurs in the case of a perpendicular insertion due to manufacturing inaccuracies or material wear, is avoided.

According to another advantageous embodiment, the ground contact element may be realized as a structural plate, preferably having at least one stiffening profile extending along a longitudinal direction.

Due to the shape which is planar and realized as a structural plate, the ground contact element has a particularly stable abutment against the respective substratum and simultaneously the necessary torsional stiffness. Due to the stiffness of the ground contact element, particularly advantageously, the stiffness of the fixing bracket can be improved in the area of the connection, particularly preferably transverse to the dimension of the stiffening profile(s). Particularly advantageously, all stiffening profiles of the ground contact element are oriented in the longitudinal direction. Even if the stiffness of the ground contact element transverse to the stiffening profiles turns out to be low as a result, the connection to the fixing bracket can again particularly advantageously reinforce the stiffness of the connection between ground contact element and fixing bracket.

In addition, the design as a structural plate enables a particularly advantageous and space-saving stacking of the ground contact elements.

Advantageously, the surface adhesion of the ground contact element already provides a sufficient stabilization of the abutment, which makes relatively little ballast sufficient to secure the mounting device. In the same way, by means of the design as a structural plate, a fixed abutment can be achieved even with a substratum with inclination without the existence of the danger of tipping over. Furthermore, due to a preferably elongated design of the structural plate, the mounting device extends relatively far below the surface elements, thus, particularly in the case of an arrangement of the surface elements along their longitudinal direction, the so-called fixation on the longitudinal edge, achieving a stabilization which is as extensive as possible and protects the surface elements against sagging, bending or drooping, which reduces the material fatigue of the surface elements, promotes a longer service life of the surface elements and allows wind loads to be better absorbed. Thus, a real clamping can be achieved, in which a fixation is carried out at both ends of the longitudinal edge of the surface elements far inside along the longitudinal edge. In this case, a deformation of the ground contact element, for example due to weather-related temperature or moisture influences, is prevented by means of at least one stiffening profile. The ground contact element can also be further stiffened by the weighting down with ballast.

According to another advantageous embodiment, the ground contact element may have a receiving slot at two ends opposite to each other in the longitudinal direction, said receiving slot serving to receive the fixing brackets.

Preferably, the receiving slot is disposed on at least one stiffening profile, particularly preferably disposed so as to extend across several stiffening profiles as a continuous recess. This allows fixing brackets to be attached to the ground contact element along the longitudinal orientation from two opposite directions, which, in the case of a force application, for example by strong winds, entering approximately along the longitudinal direction results in the advantage that force is applied only to fixing brackets on one side against their clipping direction, a detaching of these fixing brackets being prevented by opposing fixing brackets disposed on a common surface element.

According to another advantageous embodiment the receiving slot may extend across two, preferably three, stiffening profiles.

Thus, particularly advantageously, several fixing brackets, as well as fixing brackets of different embodiments, can be disposed, in particular clipped, on the ground contact element. Furthermore, the connection between ground contact element and fixing bracket becomes particularly stable due to the potentially larger abutment surface along a horizontal direction, in particular if pressure is perpendicularly applied to the connection by means of the weight of supported surface elements. Particularly advantageously, an additional reinforcement of the fixing bracket in the area of the connection to the ground contact element is thereby also achieved. Furthermore, the inserted fixing brackets can further contribute to the stiffening and stabilization of the ground contact element, preferably perpendicular to the stiffening profile(s).

According to another advantageous embodiment, the ground contact element may have, in particular in the area of the stiffening profiles, a securing tongue protruding into the mounting slot and being passable when connecting, in particular clipping on, a fixing bracket and being automatically transferrable into a securing position when or immediately before the end position of a fixing bracket is reached.

Preferably, the securing tongue is temporarily deformable when clipping on a fixing bracket, which allows the fixing bracket to be pushed to an end position before the securing tongue takes its securing position by at least approximately returning to its initial position. Further preferably, a recess is located opposite on the fixing bracket, said recess being positioned in such a manner that the securing tongue snaps into the recess of the fixing bracket when a defined end position is reached. By means of the securing tongue, a displacement of the fixing bracket is prevented and additionally an acoustic signal is generated by the snapping of the securing tongue, said signal communicating the reaching of the end position.

The securing tongue can be realized or comprised advantageously integrally, preferably monolithically, by the ground contact element. For example, the securing tongue can be realized as a punch contour.

According to another advantageous embodiment, the fixing bracket may have a tab at an end connected or connectable to the ground contact plate, said tab at least partially engaging a stiffening profile.

Thus, a fixing bracket can be connected particularly advantageously to the ground contact element, the fixing bracket being secured against slipping or turning out of position without increasing the expenditure of force for clipping on the fixing bracket. Furthermore, the tab serves as a guidance to attach the fixing bracket to the ground contact plate at an advantageous position.

According to another advantageous embodiment, the fixing bracket may have a fixing portion for engagement into the ground contact element, and in particular for engaging a stiffening profile, and a distance portion which adjoins the fixing portion and is preferably monolithically connected to it, the distance portion being made of an at least partially elastically deformable material, preferably aluminum. The distance portion essentially ensures the distance between the ground contact element and the mounted surface element. For example, the distance portion can be designed in all fixing brackets in such a manner that a distance of at least 100 mm is guaranteed between the upper edge of the ground contact element and the lower edge of the surface element if the ground contact element is laid above ground and is not integrated or buried in the substrate of a green roof.

Advantageously, the fixing portion can be made of the same material as the distance portion. Due to the connection to the ground contact element, the fixing bracket can be stiffened in a portion on the ground side and simultaneously have an elasticity in the adjoining distance portion, wherein said elasticity can, in this case, serve as a movable bearing to flexibly fix or support the surface elements.

In this case, the distance portion and the fixing portion can have different lengths, which allows the fixing brackets to vary in their height and encompass or enclose a different number of stiffening profiles. Also, for example, two distance portions can be disposed on one fixing portion. In this case, this allows the fixation of two surface elements on one fixing bracket, preferably in the case of an east-west arrangement of the surface elements. Furthermore, on its end facing away from the ground contact plate, the distance portion can have different designs for the arrangement on a surface element. As an alternative to a monolithic design, different designs are possible, such as a connection of the fixing and distance portion by soldering or screwing, the monolithic design as a particularly stable and long-lasting design being preferred. By using at least partially elastic material, a flexibility of the fixing bracket can be achieved particularly advantageously, which makes the fixing bracket resistant to thermally induced deformations and allows at least partially adjustments of the orientation of the fixing bracket during mounting and, thus, also an adjustment of the surface elements.

According to another advantageous embodiment, the ground contact element may have a fixing opening, in particular an elongated hole, via which the ground contact element is able to be connected, preferably screwed, to a substratum.

This allows the ground contact element to be particularly advantageously attached to a roof structure or to be connected, for example, to an anchor unit sunk or capable of being sunk into the ground. In this case, the design as an elongated hole enables adjustments of the positioning of the ground contact element, in particular along the longitudinal orientation of the elongated hole. In addition to the elongated hole, the ground contact element can comprise other perforations which can also be elongated or point-shaped and provide further options for anchorage to the substratum or for the draining of waterlogging.

According to another advantageous embodiment, the ground contact element may have a dimension of at least 700 mm, preferably between 750 mm and 900 mm, in the longitudinal direction.

These dimensions have proven to be particularly advantageous in order to generate a stable adhesion to the substratum just by the mere abutment of the ground contact element. Furthermore, this length is particularly well compatible with usual dimensions of surface elements, the ground contact element protruding far enough below the surface element to enable a stable support, preferably a real ¼ clamping on the longitudinal edge, and to prevent a sinking of the surface element in its center or an excessive load due to wind loads, in particular if the surface elements are contacted or held on their longitudinal side.

According to another advantageous embodiment, the ground contact element may have border beadings at the borders in a width direction, said border beadings extending in the longitudinal direction and reinforcing the border mechanically and/or enabling a secure support of ballast weights having a regular, in particular even, bottom side.

By means of the border beadings, a preferably at least approximately level plane for the support of ballast is created, which favors in particular the support of ballast having an even and/or planar bottom side. At the same time, the ground contact plate is mechanically reinforced in its border area, which prevents in particular a breaking of the border and, thus, a concomitant loss of ballast elements. In addition to the border beadings, the ground contact element can have further indentations and/or protrusions which can be disposed on the border or away from the border and can further improve the mechanical stability of the ground contact element.

According to another advantageous embodiment, the ground contact element may have a friction-increasing coating, preferably of a partially elastic material, on a bottom side, at least sectionally in areas coming into contact with a substratum.

Thus, the positionally stable fixation of the ground contact element can be further improved and, particularly if no deep anchoring of the ground contact plate is possible, for example due to the roof structure or soil composition, an additional stability by means of surface adhesion can be achieved. The coating can, for example, be made on the basis of EPDM or SBR rubber, other materials also being conceivable. As an alternative or in addition to a friction-increasing coating, it is also conceivable that the bottom side of the ground contact element has protrusions, such as nails or pins, and/or is roughened to further increase the friction.

Furthermore, the abovementioned object is attained by a mounting system having at least one mounting device, preferably a plurality of mounting devices, according to any one of the embodiments described above and at least one surface element, preferably a plurality of surface elements, in particular photovoltaic or solar thermal modules, at least one fixing bracket of the mounting device being connected to the surface element, preferably via a clamping element.

The clamping elements can be connected to the fixing bracket on the one hand and to the surface element on the other hand. Such clamping elements are known in different embodiments.

To avoid unnecessary repetitions, reference is made to the mounting device described above with regard to the advantageous effects and the advantageous embodiments of the mounting system.

In summary, the mounting system according to the invention enables the combination of at least two fixing brackets on one or several mounting devices in which a ground contact element and fixing brackets are realized detachably from each other and can be connected without tools, which makes mounting and adjustments which may be necessary significantly easier.

Advantageously, two ground contact elements may be provided along a longitudinal side and a short side of the surface element in each case, each ground contact element being connected to the surface element via a fixing bracket. In this case, furthermore, the fixing brackets along the longitudinal side may particularly advantageously be of the same height in their dimension in the height direction, in particular relative to the distance portion. However, in the case of adjacent fixing brackets along the short side of the surface elements, it can be particularly advantageous that they are of a different height, preferably in their dimension in the height direction. Thus, supports having a south or east-west orientation can be provided in a particularly advantageous manner, in which, in this case, the surface elements have an inclination caused essentially by the fixing brackets of different heights. In this case, the inclination can advantageously be realized along the short side of the surface elements.

In this case, the at least two fixing brackets can differ particularly in the height of their distance portions, thus allowing advantageously a stepped or inclined arrangement of a surface element, an inclined arrangement, for example for an advantageous orientation of a photovoltaic module, being made possible. Furthermore, the fixing brackets can additionally or alternatively differ in the length of their fixing portion or share a fixing portion. In this way, for example in the case of a fixing bracket having a longer distance portion, a stable support can be guaranteed by a fixing portion which is also elongated.

Particularly advantageously, a longitudinal edge of the surface element may be disposed essentially parallel to a longitudinal direction of the ground contact element, in particular parallel to a dimension of a stiffening profile of the ground contact element. Thus, a good reinforcement of the mounting system is achieved in a particularly advantageous manner. Furthermore, it is achieved that the ground contact element extends relatively far below the surface element, which reduces a bending of the surface element during an application of a force, in particular under wind action.

In another particularly desirable embodiment, the connection between the fixing bracket and the surface element may be realized on the longitudinal edge of the surface element. Thus, an advantageous and space-saving realization of the mounting system can be achieved, which is also stable with large-surface surface modules and can absorb and deflect wind loads. In addition, in an advantageous combination with the preceding embodiment, it can be achieved that the contact points or contact areas between the fixing bracket and the surface element are disposed relatively far from the corners between the longitudinal side and the short side. Thus, particularly advantageously, a bending of the surface element can be prevented or minimized.

Further advantageously, a row of surface elements may be disposed in such a manner that the surface elements each adjoin or oppose each other with a short side, wherein, with the exception of outer ground contact elements, two fixing brackets per ground contact element establish a connection to two adjacent surface elements in each case. Thus, on the one hand, the number of ground contact elements can be reduced. At the same time, a particularly stable support can be achieved, in particular if the longitudinal direction of the ground contact elements runs parallel to the longitudinal side of the surface elements. Furthermore, particularly advantageously, a fixation can be achieved relatively far inside along the longitudinal sides of the surface elements.

### BRIEF DESCRIPTION OF THE DRAWINGS

Below, the invention at hand is further explained with reference to merely schematic drawings showing exemplary embodiments of the invention.

FIG. 1A perspective view of a mounting device according to the invention in a first embodiment

FIG. 2a A first perspective view of a ground contact element according to the invention in a first embodiment

FIG. 2b A second perspective view of a ground contact element according to the invention in a first embodiment

FIG. 3A perspective view of a fixing bracket according to the invention in a first embodiment

FIG. 4A perspective side view of a mounting device according to the invention in a second embodiment

FIG. 5A perspective view of a mounting system according to the invention in a first embodiment

### DETAILED DESCRIPTION

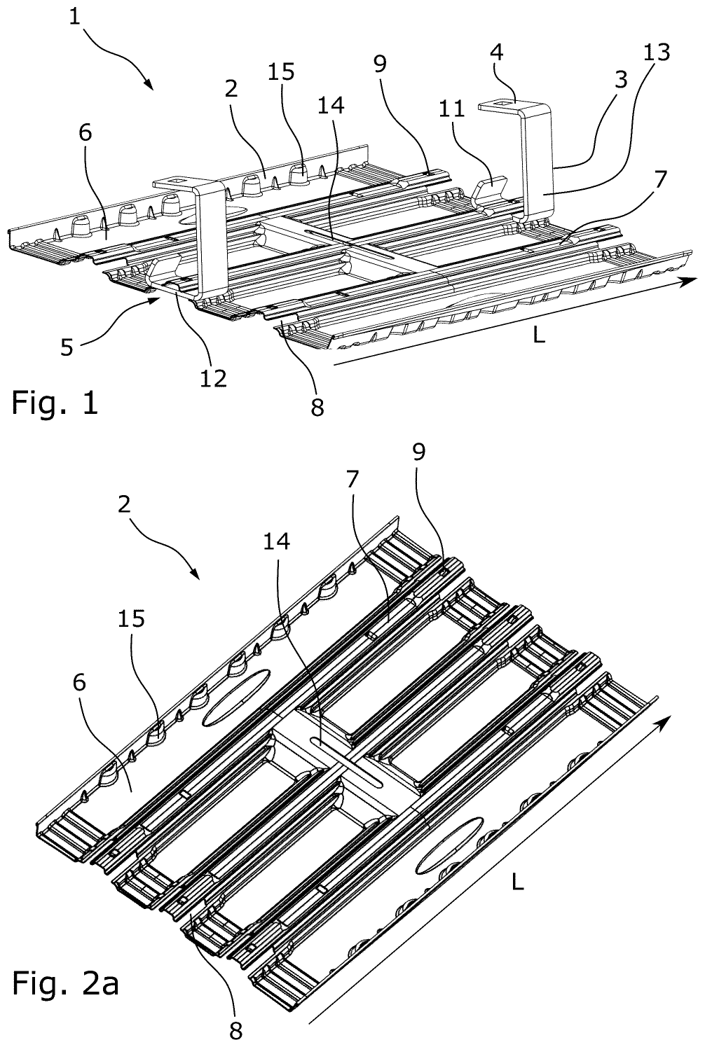

In FIG. 1, a first embodiment of a mounting device 1 according to the invention is shown, said mounting device 1 comprising a ground contact element 2 realized as a structural plate 6. In this case, structural plate 6 has stiffening profiles 7 stabilizing structural plate 6, in particular mechanically, wherein the number of stiffening profiles 7 can vary. A receiving slot 8 is disposed on stiffening profiles 7, said receiving slot 8 running through all stiffening profiles 7 in this illustration, other embodiments, such as a receiving slot 8 which is disposed only across one stiffening profile 7, being conceivable. Structural plate 6 furthermore comprises border beadings 15 on the border side which are adjusted in particular in their height to stiffening profiles 7, whereby a plane for the support of ballast is realized by border beadings 15 and stiffening profiles 7.

Furthermore, structural plate 6 can have a friction-increasing coating on the ground side (not shown in the illustration). Fixing brackets 3 are fixed to structural plate 6 by means of an insertion connection 5 realized along longitudinal direction L, securing tongues 9 being realized on stiffening profiles 7, said securing tongues 9 being passable by an at least partial deformation during the establishment of insertion connection 5 without tools and snapping into a recess 10 disposed on fixing bracket 3 by an at least approximate return deformation when fixing bracket 3 reaches a defined end position and, thus, taking a securing position, whereby fixing brackets 3 are fixed in an end position and an acoustic and/or haptic signal communicates that this end position has been reached. Advantageously, a fixing bracket 3 is disposed on each of opposing ends of ground contact element 2. As will be described hereinafter, each of the two fixing brackets 3 can—with the exception of outer ground contact elements 2 disposed on the border side, where applicable—establish a connection to a surface element which is not illustrated in FIG. 1. In FIG. 1 it is visible that fixing brackets 3 protrude quite far below adjacent surface elements due to the elongated design of ground contact element 2 or the large dimension in longitudinal direction L and, thus, allow a very stable support.

Fixing brackets 3 comprise a fixing portion 12 for engagement into ground contact element 2, in particular for engaging a stiffening profile 7, wherein fixing portion 12 can be designed differently, particularly with respect to its length, thus allowing different numbers of stiffening profiles 7 to be comprised. Furthermore, a tab 11 is disposed on fixing portion 12, said tab 7 comprising at least partially a stiffening profile 7 and, thus, preventing fixing bracket 3 from slipping out of position and being able to make the insertion of fixing bracket 3 easier as a positioning aid. Instead of a tab 11, also another fixing bracket 3, which is realized identically or differently, and which is in particular reflected, can be disposed on the same fixing portion 12. Distance portion 13 is realized preferably monolithically on fixing portion 12 and can be realized differently with respect to its height in order to enable, for example, an inclined and/or stepped arrangement of surface elements 16. Fixing elements 4 are disposed on distance portion 13 on the side facing away from ground contact element 2 and can be realized, for example, as a clip or an insertion connection.

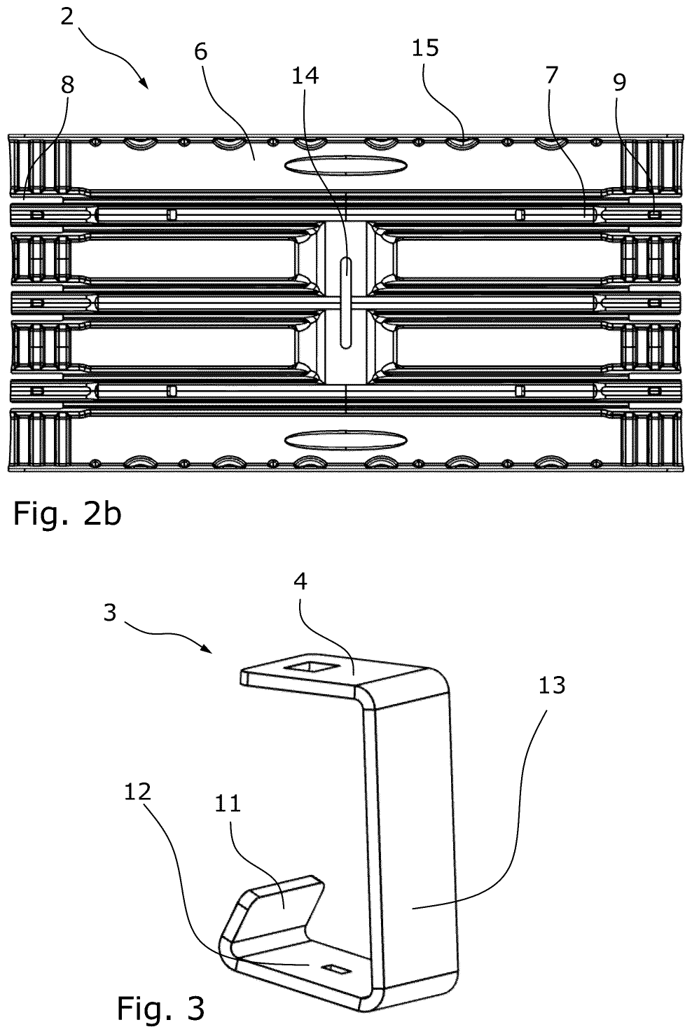

In FIGS. 2a and 2b, a ground contact element 2 according to the invention is shown which is realized as a structural plate 6 and comprises stiffening profiles 7 stabilizing structural plate 6 in particular mechanically, wherein the number of stiffening profiles 7 can vary. Furthermore, structural plate 6 comprises border beadings 15 which are disposed at least approximately equally in their height as stiffening profiles 7, thus realizing overall a plane, for example, for the support of ballast. Border beadings 15 also stabilize the border mechanically, in particular against a breaking or deformation which can lead to a loss of ballast and, thus, the securing of the mounting device. A receiving slot 8 is disposed on stiffening profiles 7, said receiving slot 8 being designed for realizing an insertion connection 5 with a fixing bracket 3. Furthermore, stiffening profiles 7 comprise securing tongues 9 which interact with a recess 10 on fixing bracket 3 in order to communicate a reaching of an end position of fixing bracket 3 and to fix them. Optionally, structural panel 6 can comprise a coating, for example of EPDM, on the ground side in order to increase the friction with respect to the substratum and to positionally stably fix the structural plate. In addition to border beadings 15 and stiffening profiles 7, the structural plate can have further indentations and/or protrusions which can, for example, further improve the mechanical stability. Furthermore, structural plate 6 comprises an elongated hole 14, for example for the connection to an anchor unit sunk or capable of being sunk into the ground, adjustments along the longitudinal direction being possible due to the elongated design. Optionally, structural plate 6 can have further perforations in addition to elongated hole 14.

In FIG. 3, a fixing bracket 3 according to the invention is shown as an example, said fixing bracket 3 comprising a fixing portion 12 for engagement into ground contact element 2 and in particular for engaging a stiffening profile 7, wherein fixing portion 12 can be designed differently, particularly with respect to its length, thus allowing different numbers of stiffening profiles 7 to be comprised. Furthermore, at least one recess 10 is disposed on the fixing portion, further preferably a number of recesses 10 corresponding in particular to the number of comprised stiffening profiles 7, which is configured to interact with a securing tongue 9 disposed on stiffening profile 7 in order to fix the fixing bracket in an end position of insertion connection 5 and to communicate, in particular acoustically, that said end position has been reached. Furthermore, a tab 11 is disposed on fixing portion 12, said tab 11 comprising at least partially a stiffening profile 7 and, thus, preventing fixing bracket 3 from slipping out of position and being able to make the insertion of fixing bracket 3 easier as a positioning aid. Instead of a tab 11, also another fixing bracket 3, which is realized identically or differently and which is in particular reflected can be disposed on the same fixing portion 12. Distance portion 13 is realized preferably monolithically on fixing portion 12 and can be realized differently with respect to its height in order to enable, for example, an inclined and/or stepped arrangement of surface elements 16. Fixing elements 4 are disposed on distance portion 13 on the side facing away from ground contact element 2 and can be realized, for example, as a clip or an insertion connection. Preferably, fixing bracket 3 is made of an at least partially elastically deformable material, preferably of aluminum, which makes the fixing bracket particularly resistant to thermal deformation and allows that it can be at least partially adjusted by deformation during mounting.

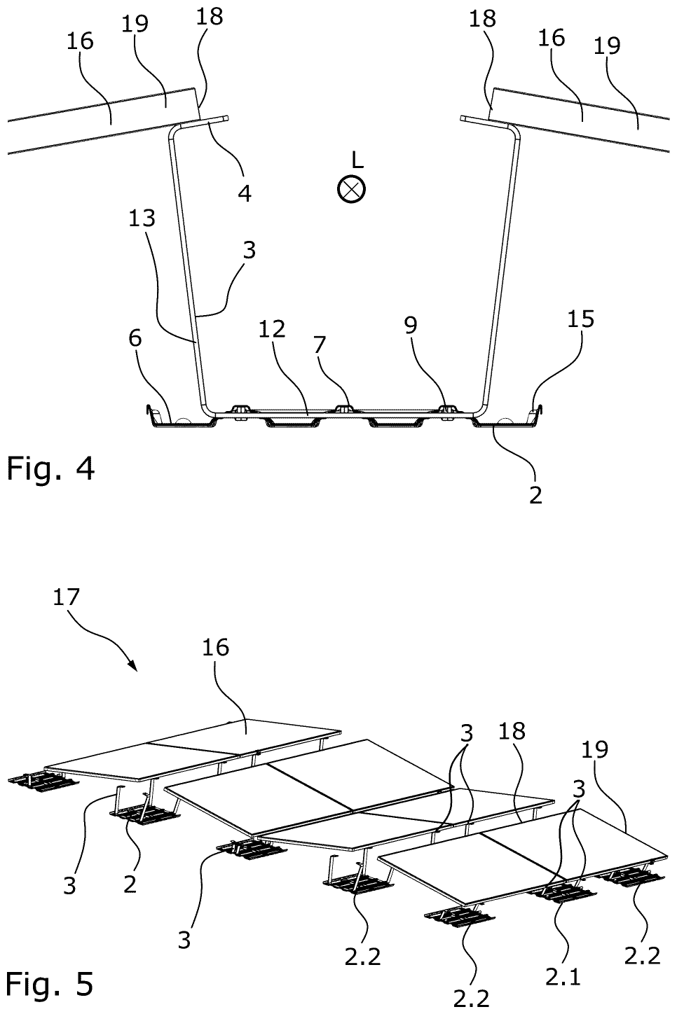

In FIG. 4, a mounting device in a second embodiment is shown, comprising a ground contact element 2 realized as a structural plate 6. In this case, structural plate 2 has stiffening profiles 7 stabilizing structural plate 6 in particular mechanically, wherein the number of stiffening profiles 7 can vary. Securing tongues 9 being realized on stiffening profiles 7, said securing tongues 9 being configured to interact with recesses 10 on fixing bracket 3 in order to fix it in an end position and to communicate by means of an acoustic and/or haptic signal that the end position has been reached. Furthermore, structural plate 6 comprises border beadings 15 on the border side which are adjusted in particular in their height to stiffening profiles 7, whereby a plane for the support of ballast is realized by border beadings 15 and stiffening profiles 7. Fixing bracket 3 comprises a fixing portion 12 for engagement into ground contact element 2 and in particular for engaging a stiffening profile 7, wherein fixing portion 12 can be designed differently, particularly with respect to its length, thus allowing different numbers of stiffening profiles 7 to be comprised. In this embodiment, two distance portions 13 are disposed on fixing portion 12, each distance portion 13 having a fixing element 4 for abutment against a surface element 16. The distance portions can be realized identically or differently in their length in order to enable a stepped arrangement.

The viewing direction in FIG. 4 extends into the drawing plane along longitudinal direction L of ground contact element 2 and looks perpendicularly at a short side 19 of surface elements 16. Thus, longitudinal direction L runs parallel to longitudinal sides 18 of surface elements 16. Thus, stiffening profiles 7 act particularly well in the reinforcement of the mounting system along longitudinal sides 18 of surface elements 16. Furthermore, thus, fixing brackets 3 can engage or be fixed quite far inside along longitudinal sides 18, which also reduces the bending of the surface elements.

In FIG. 5, a mounting system 17 according to the invention is shown which comprises several mounting devices 1. In this case, each mounting device 1 comprises a ground contact element 2 realized as a structural plate 6. Moreover, mounting devices 1 comprise fixing brackets 3 which can be realized identically or differently within a mounting device 1 and which can be realized identically or differently within a mounting system 17. The illustration shows an arrangement of surface elements 16 in an orientation in which a longitudinal side is connected to, in particular clamped with, fixing brackets 3. Since ground contact element 2 is designed as elongated structural plate 6, the distances of the fixing locations can be shortened along longitudinal sides 18 of surface elements 16, which particularly improves the mechanical stability and the resistance to wind loads. For this purpose, ground contact element 2 can have preferably a length of at least 700 mm. By means of different fixing brackets 3, in particular fixing brackets 3 of different heights, an inclination of surface elements 16 can be achieved in order to generate a support having a south orientation or an east-west orientation.

As can be seen, longitudinal direction L of ground contact elements 3 extends parallel to longitudinal sides 18 of surface elements 16. Surface elements 16 are disposed in such a manner that they adjoin each other or oppose each other with short sides 19. Inner ground contact elements 2.1 each have two fixing brackets 3, which are each fixed to two adjacent fixing elements 16, preferably at longitudinal side 18. Outer ground contact elements 3 or ground contact elements 3 on the border side along longitudinal sides 18 can advantageously have only one fixing bracket 3 which establishes a connection to a surface element 16, preferably along longitudinal side 18, in each case.

In addition, wind deflector elements, preferably wind deflector plates, may be disposed on fixing brackets 3 and/or on the surface elements, which is not illustrated in detail in FIGS. 4 and 5. Said wind deflector elements are usually made of a metal plate and direct the wind, preferably in a south orientation of the system, in such a manner that a pressing suction acts on the surface elements in the direction of the substratum. Additionally, gaps can be realized between longitudinal edges 18 of surface elements 16 and the wind deflector elements. The wind deflector elements can be angled and protrude slightly beyond an upper longitudinal edge of the surface element.

### LIST OF REFERENCE SIGNS

1 mounting device
2 ground contact element
2.1 inner ground contact element
2.2 outer ground contact element
3 fixing bracket
4 fixing elements
5 insertion connection
6 structural plate
7 stiffening profile
8 receiving slot
9 securing tongue
10 recess
11 tab
12 fixing portion
13 distance portion
14 fixing opening
15 border beadings
16 surface element
17 mounting system
18 longitudinal side
19 short side
L longitudinal direction

1. A mounting device for surface elements having a ground contact element comprising a fixing bracket which is connectable to the ground contact element and comprises or is able to receive fixing elements at an end facing away from the ground contact element, said fixing elements serving to fix the surface elements, the connection between the ground contact element and the fixing bracket being detachable.

2. The mounting device according to claim 1,
wherein
the connection between the ground contact element and the fixing bracket is establishable without tools and is detachable without tools.

3. The mounting device according to claim 1,
wherein
the connection between the ground contact element and the fixing bracket comprises an insertion connection.

4. The mounting device according to claim 3,
wherein
the insertion connection is configured in such a manner that an insertion direction runs essentially parallel to a base plane of the ground contact element.

5. The mounting device according to claim 1,
wherein
the ground contact element comprises a structural plate having at least one stiffening profile extending along a longitudinal direction.

6. The mounting device according to claim 1,
wherein
the ground contact element has a receiving slot at two ends opposite to each other in the longitudinal direction, said receiving slot serving to receive the fixing brackets.

7. The mounting device according to claim 6,
wherein
the receiving slot extends across two, stiffening profiles.

8. The mounting device according to claim 6,
wherein
the ground contact element has, in the area of the stiffening profiles, a securing tongue protruding into the mounting slot and being passable when connecting to a fixing bracket and being automatically transferrable into a securing position when or immediately before the end position of a fixing bracket is reached.

9. The mounting device according to claim 1,
wherein
the fixing bracket has a tab at an end connected or connectable to the ground contact plate, said tab at least partially engaging a stiffening profile.

10. The mounting device according to claim 1,
wherein
the fixing bracket has a fixing portion for engagement into the ground contact element, and for engaging a stiffening profile, and a distance portion which adjoins the fixing portion and is monolithically connected to it, the distance portion being made of an at least partially elastically deformable material.

11. The mounting device according to claim 1,
wherein
the ground contact element has a fixing opening via which the ground contact element is able to be connected to a substratum.

12. The mounting device according to claim 1,
wherein
the ground contact element has a dimension of at least 700 mm in the longitudinal direction.

13. The mounting device according to claim 1,
wherein
the ground contact element has border beadings at the borders in a width direction, said border beadings extending in the longitudinal direction and reinforcing the border mechanically and/or enabling a secure support of ballast weights having a regular bottom side.

14. The mounting device according to claim 1,
wherein
the ground contact element has a friction-increasing coating on a bottom side, at least sectionally in areas coming into contact with a substratum.

15. A mounting system having at least one mounting device according to claim 1 and at least one surface element, at least one fixing bracket of the mounting device being connected to the surface element via a clamping element.

16. The mounting system according to claim 15,
wherein
a longitudinal edge of the surface element is disposed essentially parallel to a longitudinal direction of the ground contact element.

17. The mounting system according to claim 16,
wherein
the connection between the fixing bracket and the surface element is on the longitudinal edge of the surface element.

18. The mounting system according to claim 15,
wherein
a row of surface elements is disposed in such a manner that the surface elements each adjoin or oppose each other with a short side, wherein, with the exception of outer ground contact elements, two fixing brackets per ground contact element establish a connection to two adjacent surface elements in each case.

19. The mounting device according to claim 1, wherein the mounting device is a flat roof or open space mounting system, and the surface elements are photovoltaic or solar thermal modules, and wherein the ground contact element also accommodates ballast weights.

20. The mounting device according to claim 1, wherein the fixing elements are clips.
